(19) United States
(12) Patent Application Publication
(10) Pub. No.: US 2015/0178459 A1
(43) Pub. Date: Jun. 25, 2015

(54) SYSTEM AND METHOD FOR MANAGEMENT OF PATIENTS AND CRITICAL INFORMATION

(71) Applicant: Diagnotes, Inc., Indianapolis, IN (US)

(72) Inventors: David Wortman, Indianapolis, IN (US); Bharath B. Reddy Bynagari, Carmel, IN (US); Jason Vasquez, Indianapolis, IN (US); Marc Kleinman, Indianapolis, IN (US)

(21) Appl. No.: 14/417,462

(22) PCT Filed: Jul. 27, 2013
(86) PCT No.: PCT/US2013/052428

§ 371 Date: Jan. 26, 2015

Related U.S. Application Data
(60) Provisional application No. 61/676,367, filed on Jul. 27, 2012.

(51) Int. Cl. G06F 19/00

(52) U.S. Cl. CPC G06F 19/3425; G06F 19/3418; G06F 19/322

(57) ABSTRACT

A computerized system and method for management of patients and critical information is disclosed. Such a method includes receiving a medical request at a processor from a patient, identifying the patient and an available health care provider from a database with a processor, sending a push notification to a first mobile device, wherein the first mobile device is operated by the available health care provider and the push notification includes a reference to the medical request, and transmitting the medical request and a clinical information of the patient to the first mobile device upon receipt of the reference at the processor.

### CROSS REFERENCE TO RELATED APPLICATION

This application claims the benefit of and incorporates by reference herein the disclosure of U.S. Ser. No. 61/676,367, filed Jul. 27, 2012.

### BACKGROUND

Health providers utilize a call rotation to provide service to patients at all hours of the day. Patients may contact a provider's office or hospital to ask questions, request care, or generally request access to the provider at any time. Often, the doctor, nurse practitioner, or other provider who is on call is away from his or her office or hospital when the patient attempts to make contact.

Today, an office or hospital will take a message from the patient and page the on-call provider with the patient's request and/or question. The on-call provider will then call the office or hospital to request information about the patient. This telephone interaction between the on-call provider and the office or hospital requires a great deal of time as the on-call provider listens to a description of the situation and it is prone to error as the on-call provider hears the patient's request or question as written down by whomever took the message. In some situations, the on-call provider may not be able to gather all of the necessary information from the phone call and will be required to use a computer in order to pull up the patient's records, which may necessitate a visit to the office.

In other situations, an on-call provider, doctor's office, or hospital may require the assistance of one or more specialists to assist a patient. For example, a patient that arrives in a doctor's office with symptoms of shortness of breath and rapid, irregular heartbeats may be given an electrocardiogram. If the general practitioner notices irregularity in the electrocardiogram, she may desire to ask a cardiologist that she has worked with before to look at the electrocardiogram. Today, if the cardiologist is out to eat with his family, he may be required to drive home or to the office in order to view the electrocardiogram and the message from the general practitioner. In this situation, much time is wasted as the cardiologist is required to travel in order to review the electrocardiogram, and he may have to contact the general practitioner for more information about the patient's condition.

Regardless of how the patient's request for care is handled through on-call services, current solutions suffer from an inability to properly document the efforts spent resolving the patient's issue. Today, providers may be required to input billing codes and diagnostic codes within a system long after resolution of a patient's issue, thereby resulting in inaccurate information being documented. Further, current solutions suffer from the inability to provide analytics about patient care directly to a hospital, doctor's office, patient, or provider performing such care.

Accordingly, there exists a need for a system and method for management of patients and critical information that will enable providers to more efficiently handle patient requests or questions remotely. The system and method will also enable providers to efficiently escalate patient requests, questions, or issues directly to known specialists where appropriate.

### SUMMARY

The present disclosure discloses a system and method for management of patients and critical information.

In at least one embodiment of the present disclosure, a computerized method for managing patients and critical information comprises receiving a medical request from a user at a processor, identifying the user based at least in part on a demographics information stored about the user in a database, transmitting the medical request and a user clinical information to a first mobile device, wherein the first mobile device is operated by a health care provider, receiving a request from the first mobile device to escalate the medical request to a specialist, identifying a second mobile device with the processor, wherein the second mobile device is associated with the specialist, and transmitting the medical request and the user clinical information to the second mobile device.

In at least one embodiment of the present disclosure, a computerized method for managing patients and critical information comprises receiving a medical request at a processor from a patient, identifying the patient and an available health care provider from a database with a processor, sending a push notification to a first mobile device, wherein the first mobile device is operated by the available health care provider and the push notification includes a reference to the medical request, and transmitting the medical request and a clinical information of the patient to the first mobile device upon receipt of the reference at the processor.

In at least one embodiment of the present disclosure, a system for management of patients and critical information comprises a first server, the first server configured to receive at least one medical request from a first user device and transfer the at least one medical request from a patient to a second user device, and a second server, the second server electronically coupled to the first server and configured to transmit medical information of the patient to the first server, wherein the first server transmits the at least one medical request and the patient medical information to the second user device upon receiving an authorized login from the second user device.

In at least one embodiment of the present disclosure, a computerized method for management of patients and critical information comprises receiving a medical request from a user at a processor, determining at least one health care provider that is appropriate for receiving the medical request from the user using the processor, sending a notification to at least one mobile device of the at least one health care provider comprising a graphical user interface regarding the medical request, sending data from the processor to the at least one mobile device, wherein the data comprises at least a portion of the medical request, at least a portion of a medical record, and at a least a portion of a patient contact information, and facilitating at least one contact between the at least one mobile device and the user through the processor.

### BRIEF DESCRIPTION OF THE DRAWINGS

The features and advantages of this disclosure, and the manner of attaining them, will be more apparent and better understood by reference to the following descriptions of the disclosed method and system, taken in conjunction with the accompanying drawings, wherein:

FIG. 1 shows a flow chart with the steps of a method for management of patients and critical information according to at least one embodiment of the present disclosure.

FIG. 2A shows a flow chart with the steps of a method for management of patients and critical information according to at least one embodiment of the present disclosure.

FIG. 2B shows a flow chart with the steps of a method for management of patients and critical information according to at least one embodiment of the present disclosure.

FIG. 3 illustrates an architectural diagram of a system for management of patients and critical information according to at least one embodiment of the present disclosure.

FIG. 4A shows a graphical user interface connected to a system and/or performing one or more steps of a method for management of patients and critical information according to at least one embodiment of the present disclosure.

FIG. 4B shows a graphical user interface connected to a system and/or performing one or more steps of a method for management of patients and critical information according to at least one embodiment of the present disclosure.

FIG. 4C shows a graphical user interface connected to a system and/or performing one or more steps of a method for management of patients and critical information according to at least one embodiment of the present disclosure.

FIG. 4D shows a graphical user interface connected to a system and/or performing one or more steps of a method for management of patients and critical information according to at least one embodiment of the present disclosure.

FIG. 4E shows a graphical user interface connected to a system and/or performing one or more steps of a method for management of patients and critical information according to at least one embodiment of the present disclosure.

FIG. 4F shows a graphical user interface connected to a system and/or performing one or more steps of a method for management of patients and critical information according to at least one embodiment of the present disclosure.

FIG. 5A shows a graphical user interface connected to a system and/or performing one or more steps of a method for management of patients and critical information according to at least one embodiment of the present disclosure.

FIG. 5B shows a graphical user interface connected to a system and/or performing one or more steps of a method for management of patients and critical information according to at least one embodiment of the present disclosure.

FIG. 5C shows a graphical user interface connected to a system and/or performing one or more steps of a method for management of patients and critical information according to at least one embodiment of the present disclosure.

FIG. 5D shows a graphical user interface connected to a system and/or performing one or more steps of a method for management of patients and critical information according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

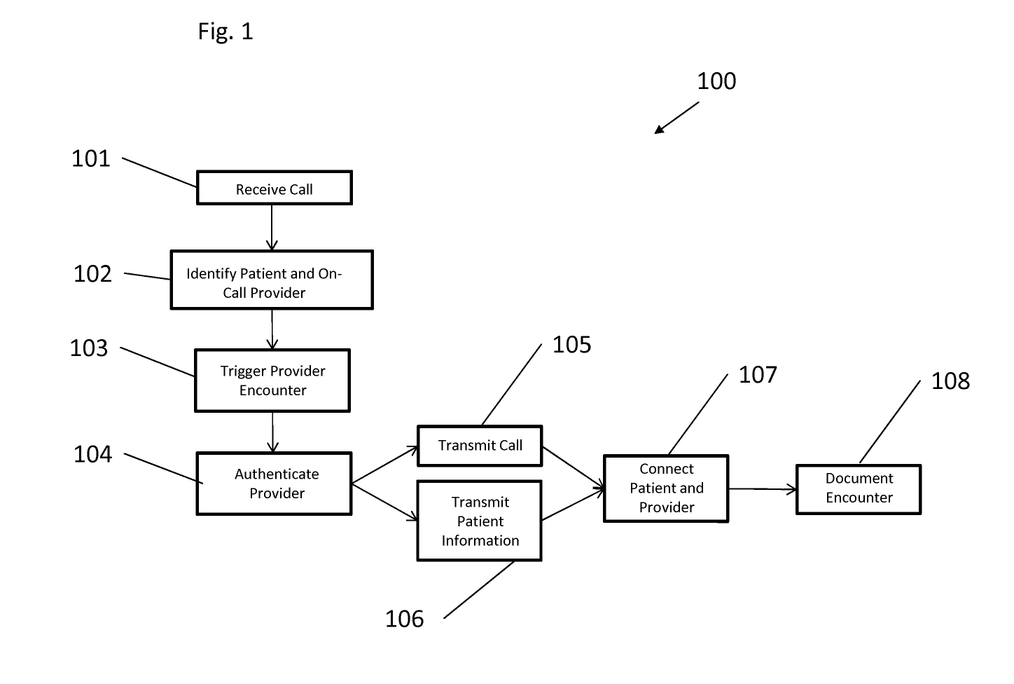

FIG. 1 shows a method 100 management of patients and critical information according to at least one embodiment of the present disclosure. As shown in FIG. 1, in at least one embodiment of the present disclosure, the method 100 includes the step 101 of receiving a call. As used in the present disclosure, a call includes, but is not limited to, a request, question or other communication originating from a patient. A call may be received in a variety of ways, such as, for example, a telephone, e-mail, facsimile or in-person request from a patient at a hospital or practitioner's office. It should be appreciated that a call may be received at any time, including off hours.

It should be appreciated that a call originating from a patient shows an interest by the patient in obtaining care from a provider. For example, a practitioner's office or hospital may receive a call indicating that a patient is reporting shortness of breath, flu-like symptoms, or other conditions. In another example, a call may be received indicating that a patient would like a refill on prescribed medication. In yet another example, a call may be received which includes a picture of a x-ray, electrocardiogram, or other test performed on a patient with a request for analysis. It should be appreciated that “patient,” as generally used herein, may refer to the actual patient, the patient's parent, family member, representative, guardian caregiver, nurse, or the like.

In at least one embodiment of the present disclosure, a call is received indicating that a patient requests some level of care in step 101. In such an embodiment, a call may be placed by a patient to an off-hours provider voicemail number. A call may also be placed to a live answering service, including, for example, a call center or secretary at a doctor's office or hospital. In at least one embodiment of the present disclosure, a patient may make a call by using a mobile application to send a secure text message. In such an embodiment, the secure text message may enable the patient to provide text, photographs, video, and other documents to the provider in the initial request.

In at least one embodiment of the present disclosure, the patient and appropriate on-call provider are identified in association with the call in step 102. In a preferred embodiment, the patient's identity is determined through a processor associating the incoming call address (i.e. telephone or mobile number, e-mail address, MMS address) with a patient identification within a database. For example, a patient calling from home to an off-hours voicemail line for a doctor's office would transmit the patient's home telephone number. In this example, a processor captures the call from the patient, including the patient's telephone number, and then filters a database of patient telephone numbers in order to identify the patient.

In at least one embodiment of the present disclosure, the appropriate on-call provider is identified in association with the call in step 102. In a preferred embodiment, the appropriate on-call provider is selected with a processor through a database of available on-call providers based on provider availability and priority. In at least one embodiment of the present disclosure, the appropriate on-call provider may be selected from a list of providers based on seniority, priority, an on-call schedule, provider geolocation in proximity to the patient provided by a mobile device, provider specialty in relationship to the call, previous relationship with the patient, and other factors. For example, a processor may identify an appropriate provider in association with an incoming call at midnight on a Friday night based on an on-call rotation where a first provider is contacted if available with an opportunity to contact a different provider in the event that the first provider is unavailable. In another example, a provider may be selected in association with a call based on information within a patient's medical history indicating that the patient has discussed previous ailments with an available on-call provider.

In a preferred embodiment, the identification of the patient and on-call provider in step 102 is performed in infrastructure available on the Internet housing a remote management application configured to receive a call as input and identify a patient from a list of patients within a database and an appropriate on-call provider from a list of on-call providers as output.

In at least one embodiment of the present disclosure, the identification of the patient in step 102 may include utilizing a voice response unit (VRU), the dialed number identification services (DNIS), and caller identification (CID) to facilitate data collection and subsequent patient identification. In at least one embodiment of the present disclosure, patient identification and processing to select an on-call provider may occur through the methods and systems disclosed in International Application No. PCT/US2012/035879, filed on Apr. 30, 2013, which is incorporated in its entirety hereby through reference, including, without limitation, the use of call centers, processing of remote data and relationships between patient and family members, and the like.

In at least one embodiment of the present disclosure, an encounter is triggered for an identified on-call provider in step 103. As used in the present disclosure, an encounter includes, but is not limited to, a request submitted to an identified on-call provider's work queue associated with a patient's call. An encounter may include information associated with the patient and the patient's call, including, but not limited to, clinical information, demographic information, contact information, family member contact information, reference numbers associated with the patient and/or previous analyses, a primary care provider, pharmacies of record, and other information. As used in the present disclosure, clinical information may include, but is not limited to, patient demographics, patient message (i.e. voicemail, e-mail, SMS, MMS, paper message, facsimile, etc.), recent notes, prescribed medications, previously prescribed medications, allergies, past or current known problems, past or current observations about the patient, doctor notes, and/or documents associated with the patient (i.e. electrocardiogram report, lab information, etc.).

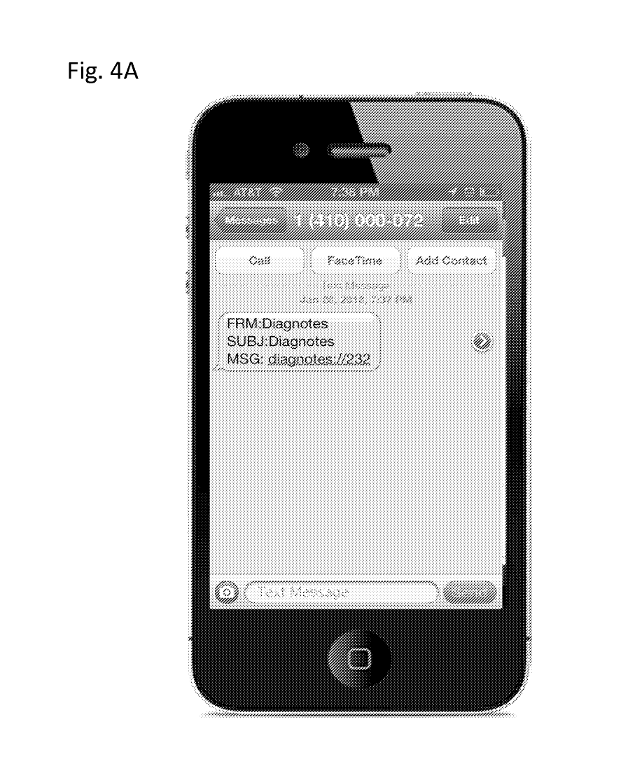

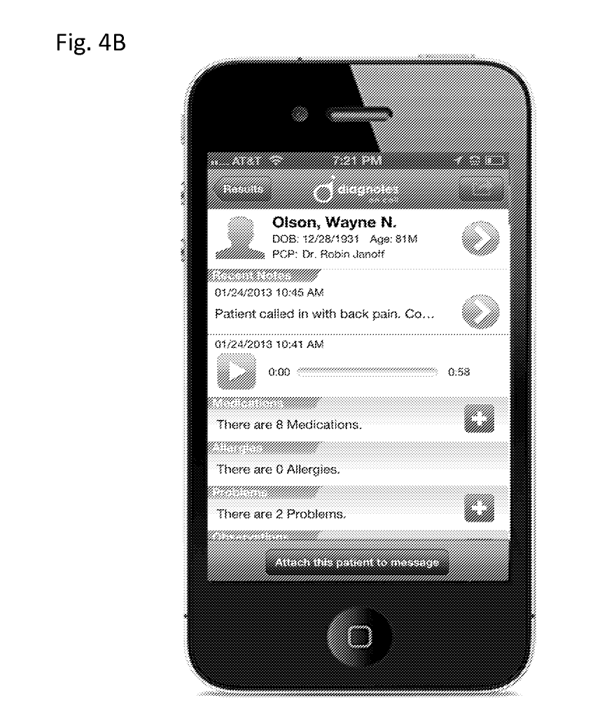

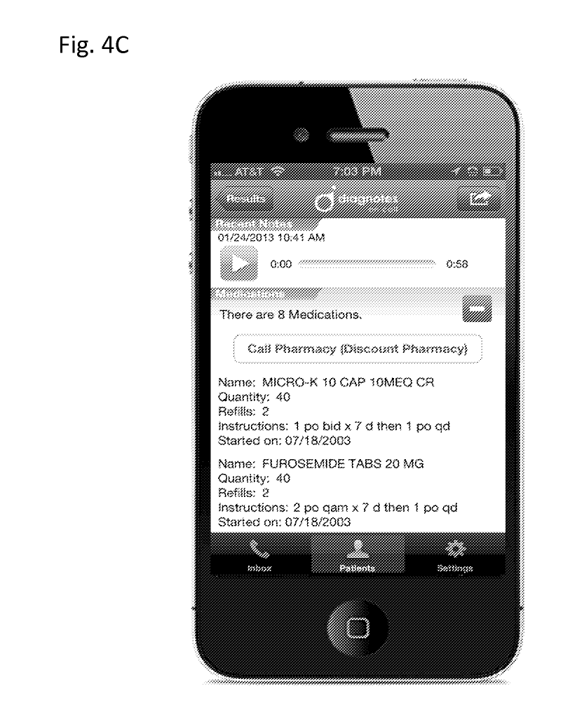

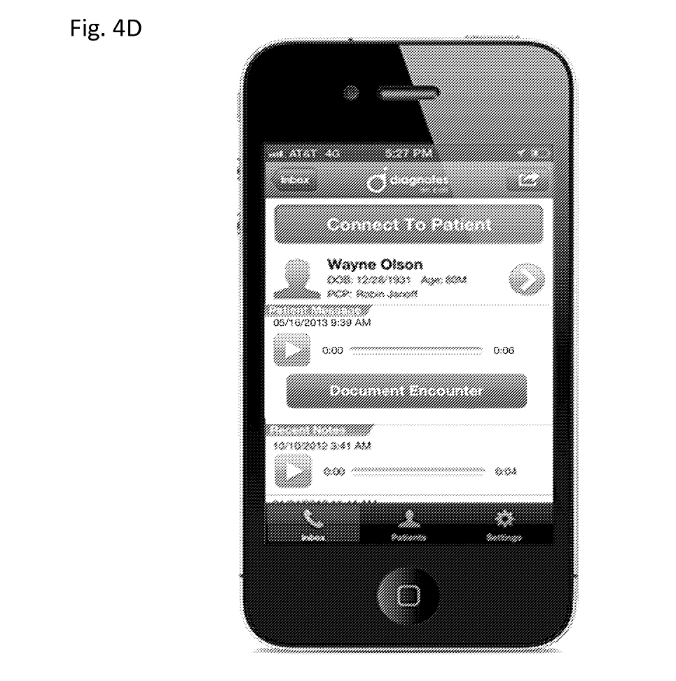

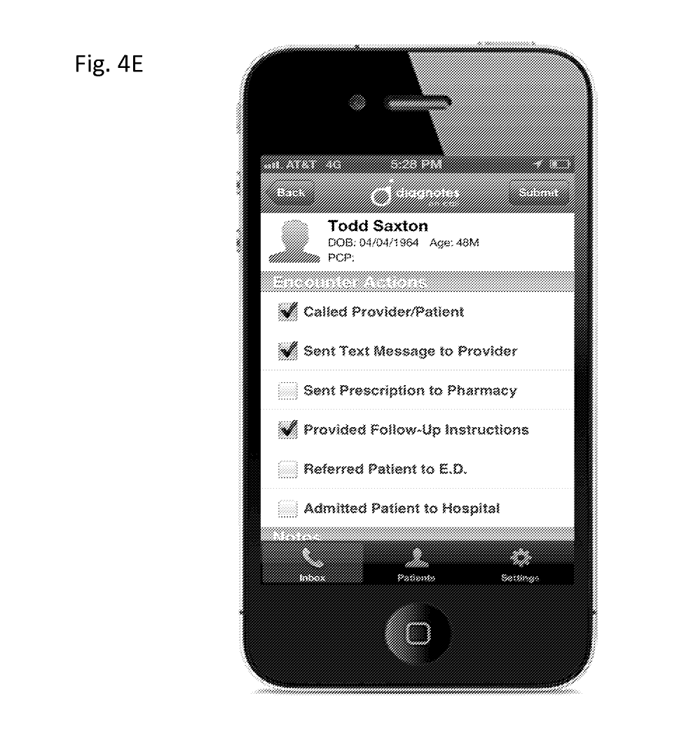

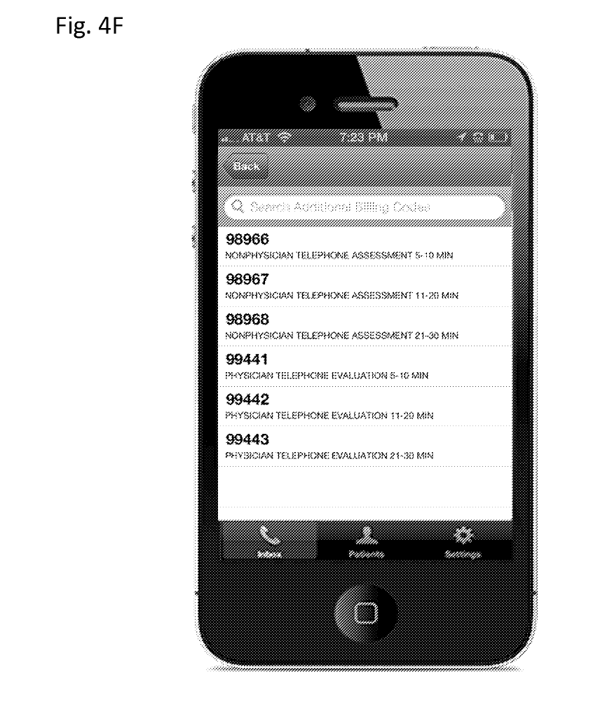

In a preferred embodiment, an encounter triggered for the provider in step 103 transmits a push notification to the provider's mobile device informing the provider that an encounter is waiting the provider's attention. In such an embodiment, the push notification may be provided through mobile operating system integrated push notification support, such as, for example, iOS, Android, Windows Phone, Blackberry OS, Nokia Asha, Sailfish OS, Windows RT, and other mobile operating systems. In at least one embodiment of the present disclosure, push notification may include an SMS, MMS, e-mail, or other communication sent to an electronic device in possession of the provider. In a preferred embodiment, the SMS, MMS, e-mail or other communication sent triggers a sound, vibration, or alarm on the electronic device to notify the provider that a message has arrived. In a preferred embodiment, a remote management application housed in web services or infrastructure available over the Internet sends the encounter trigger to the provider in step 103. In such an embodiment, the remote management application is configured to receive a call or information associated thereof, identify a patient and provider, generate an encounter to the provider, and send a push notification to the identified provider for subsequent interaction with the patient. An example of a graphical user interface displaying a push notification with a reference to an encounter is shown in FIG. 4A.

In a preferred embodiment, the push notification informs the provider that an encounter is waiting the provider's activity in step 103. In such an embodiment, the provider may interact with the application or communication associated with the push notification in order to interact with the encounter in a remote management application. In such an embodiment, a remote management application is configured to receive a provider's request to access the encounter and facilitate interaction with a patient through web services or infrastructure available over the Internet. In a preferred embodiment, the push notification contains no personally identifiable information or personally identifiable health information about the patient or the call. In such an embodiment, the push notification informs the provider that an encounter is waiting with a unique identifier or reference for the encounter that may be read by an application upon interaction with the push notification by the provider to pull information about the patient and the call.

In at least one embodiment of the present disclosure, the provider authenticates with an application prior to accessing the encounter in step 104. In such an embodiment, the provider's interaction with the push notification transmits a unique reference identifier associated with the encounter to an application or website which contains additional information for the provider. In at least one embodiment of the present disclosure, the application or website presents the provider with an authentication screen requesting that the provider submit authorized credentials prior to accessing the encounter. Authorized credentials may include, but are not limited to, a username and password, a software or hardware token generated passcode with or without a personal identification number, a certificate, a set of cached credentials stored in a private cookie, or other authentication credentials known to one of ordinary skill in the art. It should be appreciated that the authentication performed in step 104 may be secured through a communication session encrypted with secure sockets layer (SSL), transport layer security (TLS), or other encryption type. It should be appreciated that the authentication and subsequent protection of the communications between the provider and a remote management application may be designed to comply with various safeguards required by law, regulation, or contract, including, for example, the HIPAA Security Rule.

In at least one embodiment of the present disclosure, a call is transmitted in step 105. In such an embodiment, a call is transmitted to an on-call provider's electronic device in step 105. The transmission of the call may include all information associated with the call, including, but not limited to, a patient message, a time and date of the call, an identification of the person or system in which the call was performed, a telephone number or originating contact information of the person submitting the call, notes provided by a person or system receiving the call, and other information. In a preferred embodiment, the call is transmitted to the provider from a remote management application available through infrastructure over the Internet.

For example, a patient calls an automated off-hours voice recording system and leaves a message for an on-call physician describing back pain. In this example, the automated voice recording system logs the patient call and transmits it to a remote management application for processing. In this example, the remote management application identifies the patient based on the telephone number in which the patient performed the call by filtering a connected database of patients which includes contact information for each patient. The remote management application also identifies an on-call provider that is available based on a known call rotation of the available on-call providers within a database. Then, the remote management application creates an encounter that stores the patient's clinical information, demographic information, contact information, and information submitted in the call. In this example, the remote management application also generates an encounter trigger in the form of a push notification that is sent from the remote management application to the identified on-call provider which causes a pop-up message to display on the provider's cell phone. In this example, the provider interacts with the push notification through the mobile application, authenticates to the mobile application, and then receives the call from the remote management application through the mobile application.

In at least one embodiment of the present disclosure, the method 100 also includes transmitting patient information in step 106. In such an embodiment, a provider may require clinical information to properly understand how to respond to the call. To facilitate an efficient and convenient analysis of the call by the provider, patient clinical information is transmitted in real time in step 106. In a preferred embodiment, patient clinical information is retrieved in real-time by a remote management application through a virtual private network to an application programming interface to an electronic medical record portal which is then transmitted to the provider through a secure mobile application when the provider opens an associated encounter. In such an embodiment, the remote management application may be configured to enable the provider to open an encounter and be presented with real-time patient clinical information directly from an electronic medical record without needing to provide added credentials or access a secondary application. An exemplary graphical user interface of an encounter is shown in FIGS. 4B and 4C.

It should be appreciated that by transmitting the call in step 105 and the patient clinical information in real time in step 105, a provider is given a single-pane-of-glass view into the patient in order to properly address the patient's question, concern, or health-related need. It should further be appreciated that by providing real-time patient clinical information, the likelihood of the provider making a diagnosis or treatment error based on stale or improper data is lessened. For example, in the event that a patient makes a call to an automated voice answering service for an on-call provider which is received by a remote management application, as an example of execution of step 101, the patient may then walk into an emergency room to receive immediate care. If the responding on-call provider used information available to him or her at the time the patient placed the call, the responding on-call provider would not know what occurred in the patient's visit to the emergency room. However, through execution of the method 100, the on-call provider is given a real-time view into the patient's clinical information which may include new health-related data generated during the patient's trip to the emergency room, such as, for example, name of the responding physician in the emergency room that the on-call provider could contact to discuss the patient's situation, medication prescribed in the emergency room, blood pressure and temperature taken in the emergency room, and even imaging produced during the visit from radiology equipment. In another example, the real-time clinical information may enable the provider identify patient allergies to commonly prescribed medications or otherwise avoid additional patient problems by viewing the medical history of the patient through a single interaction point in connection with the patient's reported issue, problem, question, or health-related need in the call.

In at least one embodiment of the present disclosure, the patient information is transmitted from a pass-through connection between a remote management application and an electronic health record portal over a virtual private network connection. In such an embodiment, a remote management application provides real-time data to the provider by requesting such patient clinical information from an electronic medical record portal available through a virtual private network. In a preferred embodiment, the remote management application only preserves the patient clinical information for a transitory amount of time in order to transmit the information to the provider through the mobile application. In a preferred embodiment, the remote management application does not request the patient clinical information until and unless the provider opens the encounter through a mobile application or website.

In at least one embodiment of the present disclosure, the combination of transmitting the call in step 105 and transmitting real-time clinical information in step 106 provides the provider with all of the information necessary in order to respond to the call remotely from a mobile device. As discussed above, the provider is presented with a demographic information, clinical information, contact information, the content of the call discussing the patient's question, issue, concern, or health-related matter, any notes made by previously contacted providers, nurses, or staff, and any other information necessary for the provider to evaluate the patient and, if necessary, provide a diagnosis, treatment recommendation, answer, or other information in response.

In at least one embodiment of the present disclosure, an on-call provider is connected with a patient in step 107. In such an embodiment, the on-call provider may connect with the patient through a mobile application connected to a remote management application. In such an embodiment, the on-call provider may connect to the patient by sending a communication to the patient, such as, for example, an SMS, e-mail, MMS, telephone call, facsimile or other communication. In at least one embodiment of the present disclosure, the provider may send a secure communication to the patient through the mobile application. In such an embodiment, a mobile application may facilitate a secure communication by enabling a provider to send a message from his or her mobile device through an encrypted session to a remote management application which facilitates the creation of a private patient message through a secure online portal hosted by the remote management application. An exemplary graphical user interface of a connection interaction between a provider and patient is shown in FIG. 4D.

In a preferred embodiment, a remote management application facilitates a connection between the provider and the patient through a telephone call. In such an embodiment, the provider chooses to call the patient from the mobile application where the provider viewed the encounter. In such an embodiment, the mobile application sends a request to a remote management application through a secure connection that a call is requested. The remote management application then facilitates a conversation between the provider and the patient by creating a phone connection with a trusted third party which dials both parties and then initiates a conference between the patient and the provider. In such an embodiment, the conversation between the provider and patient may be stored but this is not required. It should be appreciated, of course, that the mobile application may also be configured to dial the patient directly from the provider's mobile device. However, the preferred embodiment provides an added benefit that the provider's direct phone number may remain hidden from the patient such that the patient must utilize the standard on-call process in order to have follow-up communications unless the provider provides his or her number directly to the patient.

In at least one embodiment of the present disclosure, the provider may perform other or additional activities when connecting with the patient. In such an embodiment, a mobile application may enable the provider to respond directly to a call center, nurse, or other practitioner which received the call with a message for follow up to the patient. The provider may also indicate to the call center, nurse, or other receiving entity that the patient should be directed to come into the office or hospital for further evaluation. The provider may also generate prescription requests to a pharmacy for the patient through the use of the mobile application and integration with the patient's electronic medical record portal and the remote management application.

In at least one embodiment of the present disclosure, the encounter with the provider and patient is documented in step 108. In such an embodiment, a mobile application may be configured to enable a provider to input additional information, notes, recordings, documents, photos, billing codes, and other information related to the provider's interaction with the patient. In at least one embodiment of the present disclosure, the mobile application may accept recordings or transmission of notes that the provider inputs to the mobile application in step 107. The mobile application may be configured to receive voice recordings from the provider directly to a mobile device. In such an embodiment, the mobile application may be configured to translate the voice to text directly for storage within a remote management application in association with the encounter. In at least one embodiment of the present disclosure, the mobile application may be configured to receive direct submissions from the provider via text and directed to save the text notes to a remote management application for association with the encounter. An exemplary graphical user interface of optional actions to be noted by a provider and notes is shown in FIG. 4E.

In at least one embodiment of the present disclosure, the mobile application may be configured to upload documents, photographs, video, or other files gathered by a provider in association with communicating and interacting with the patient. In one example, the provider may elect to take and transmit a photo of an electrocardiogram taken for the patient on site for further analysis at a later time. In another example, the provider may take and transmit a photo of a mole reported by the patient with a ruler so that the photo may be compared at a later to see if the mole has changed in size. In yet another example, the provider may record and transmit a video of the patient responding to questions by the provider, such as, for example, questions to test the patient's short-term memory. In yet another example, the provider may upload various files associated with diagnosing, treating, or caring for the patient, including, but not limited to, spreadsheets indicating patient test results, reports, images, or other documents.

In at least one embodiment of the present disclosure, the mobile application may be configured to enable a provider to communicate with a patient and/or specialist through video conferencing. Video conferencing may be enabled directly within the mobile application or through integration of known video conferencing solutions or conferencing solutions with video capability, such as, for example, Skype, Microsoft Live Meeting, Webex, Google Hangout, Facebook Chat, FaceTime, and other solutions. In such embodiments where the mobile application integrates with a known video conferencing provider, the mobile application may embed the video conferencing functionality within the mobile application or the mobile application may reference and load another mobile application to facilitate the video conference to the intended party. For example, the mobile application may load the Skype application with a reference to initiate a call to the intended party.

In at least one embodiment of the present disclosure, the provider may initiate a direct conference with voice and video capabilities through the mobile application. In at least one embodiment of the present disclosure, video conferencing may enable a provider to communicate with more than one party. For example, a provider may initiate a video conference with a patient to discuss a patient's question. In this example, the provider may determine that he or she cannot adequately answer the patient's question without assistance from a specialist. In this example, the provider may add the specialist to the video conference to enable a three-way voice and video conference between the provider, specialist, and patient.

In at least one embodiment of the present disclosure, the mobile application may be configured to transmit procedure codes for billing purposes and/or diagnostic codes input by a provider in association with the encounter. In such an embodiment, the provider may have a predefined list of acceptable diagnostic and billing codes and/or may manually input diagnostic and billing codes associated with the provider's interaction with the patient through the encounter. It should be appreciated that capturing the provider's billing code information immediately after connecting with the patient improves billing efficiency. For example, a provider that interacts with a patient through an encounter generated from a patient calling about back pain may discuss the matter over the phone with the patient for fifteen minutes. At the end of the call, the provider may dictate a note into the mobile application memorializing his conversation with the patient. The provider, in this example, may also generate a prescription for the patient to his or her local pharmacy for pain relief medication. At the end of this interaction, the provider may note that he or she spent thirty minutes working on the patient's encounter. As such, the provider may immediately input a thirty minute billing code into the mobile application to be saved with the encounter and thereafter billed to the patient's account. An exemplary graphical user interface for a provider to input billing codes is shown in FIG. 4F.

In at least one embodiment of the present disclosure, the provider's documentation of the encounter in step 108 may be made more efficient by prebuilding a set of common responses for the provider to include at each step. These common responses may be presented to the provider in the form of check boxes, menu selection, or other easily acceptable interface in order to enable the provider to quickly and efficiently identify commonly documented phrases, actions performed, billing codes or notes to associate with the encounter. It should be appreciated that these pre-built menu options for the provider are not required.

In at least one embodiment of the present disclosure, the remote management application may store any input from a user of the mobile application, electronic medical record information, or other information generated through execution of the methods disclosed herein or use of the system disclosed herein. In such an embodiment, the remote management application may be configured to track patient and provider activity through the mobile application. In such an embodiment, the remote management application may provide analytics and statistics about use of the system, including average response time, common diagnostic codes, common billing codes, and other information to help improve the efficiency of providing care. The analytics and statistical information generated in the remote management application may provide specific information about an individual request for care, aggregated information about multiple requests for care to one provider or more multiple providers, or any other type of analytics. For example, the remote management application may store the time of every transaction performed within the mobile application. In this example, the remote management application may generate a report for a provider that details the average response time of the provider for patients requesting care.

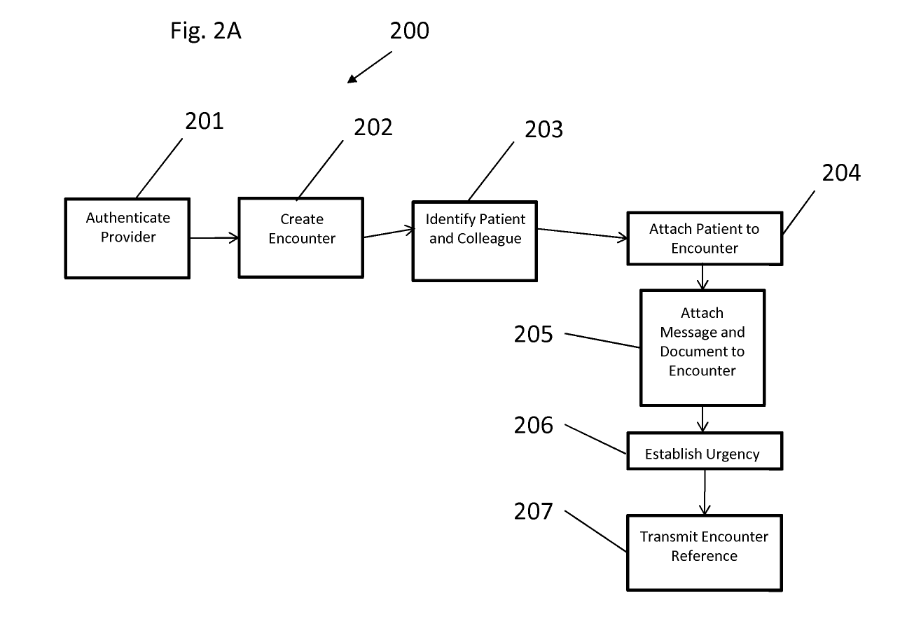

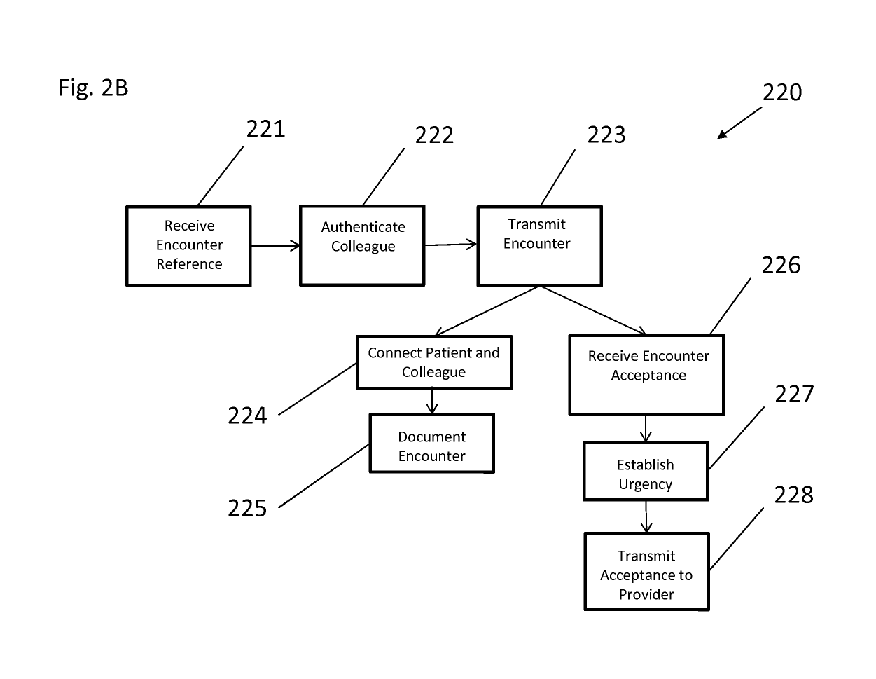

Referring now to FIG. 2A, it is shown a flowchart of a method 200 for management of patients and critical information according to at least one embodiment of the present disclosure. As shown in FIG. 2A, in at least one embodiment of the present disclosure, the method 200 includes the steps of authenticating a provider in step 201, creating an encounter in step 202, identifying a patient and colleague in step 203, attaching a patient to an encounter in step 204, attaching a message and document to an encounter in step 205, establishing an urgency in step 206, and transmitting an encounter reference in step 207. In at least one embodiment of the present disclosure, the execution of the method 200 occurs in the event that a provider intends to escalate a patient's question, issue, concern, or health-related matter to a specialist or colleague. As used herein, a specialist or college may include, but is not limited to, a nurse, doctor, or health-care staff member with appropriate knowledge to assist a patient on a specific matter. For example, a dermatologist may be a specialist in the event that a patient requests information about a mole on his or her arm that has changed color. In another example, a nurse practitioner may be a specialist in the event that a patient has a follow-up question based on a visit he or she had with the nurse practitioner the week before. In yet another example, a psychiatrist may be a specialist in the event that a patient in reporting symptoms to a general practitioner that the general practitioner may believe is related to depression. In at least one embodiment of the present disclosure, the execution of the method 200 occurs in the event that a provider intends to transfer care of a patient to a different provider.

In at least one embodiment of the present disclosure, the optional step of authenticating a provider in step 201 is included in the method 200. In such an embodiment, a provider authenticates to a mobile application with a set of credentials which are passed through a secure channel to a remote management application over the Internet in order to gain further access to the mobile application. In at least one embodiment of the present disclosure, the provider creates an encounter through the mobile application in step 202. In such an embodiment, the mobile application through the remote management application may facilitate creation of a new encounter between a provider and a colleague through a secure channel, such as, for example, a secure text message through the mobile application in step 202.

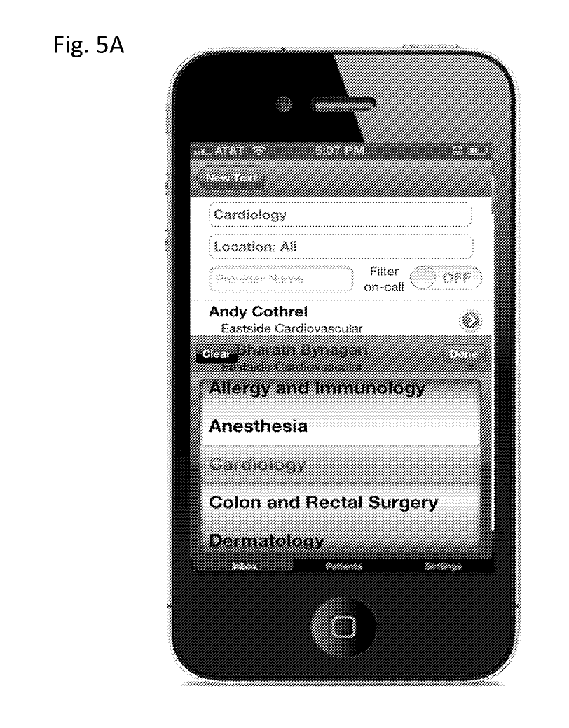

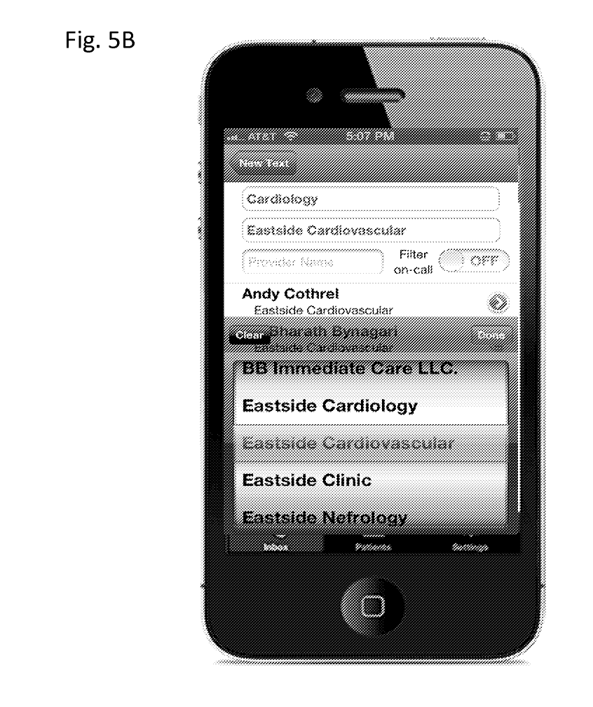

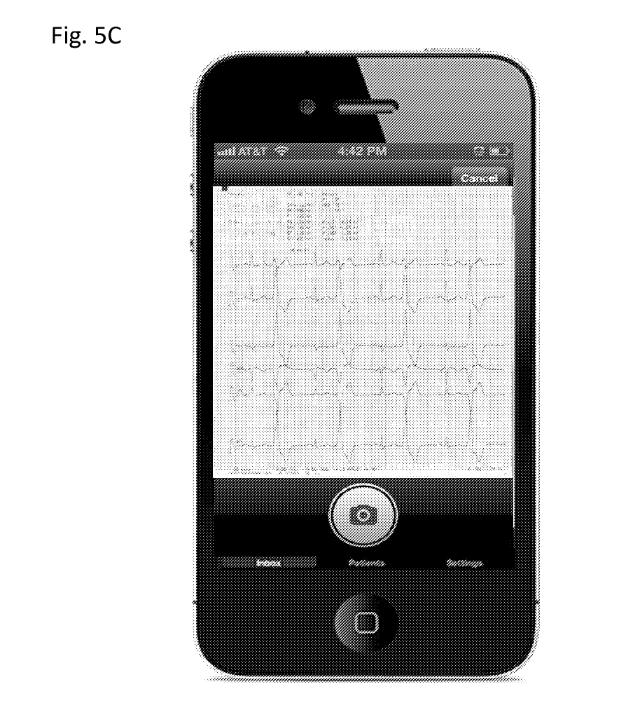

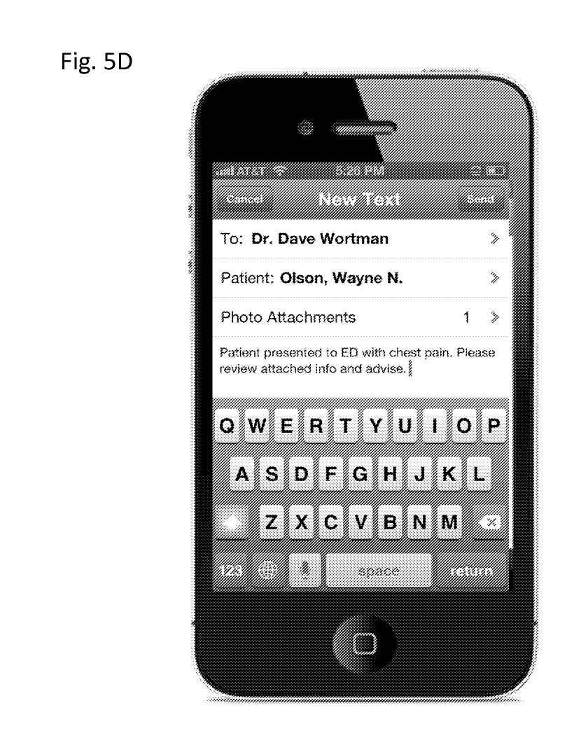

In at least one embodiment of the present disclosure, the provider indicates a desire to create a new encounter and is presented with a screen where the provider may select a colleague and patient from a list in step 203. In a preferred embodiment, the provider may filter the list of colleagues based on specialty, location, name, and/or availability. In a preferred embodiment, the provider may filter the list of patients by name, date of birth, by selecting from a quick list of commonly discussed patients, phone number, a unique patient identifier or other filtering criteria. It should be appreciated that it is within the scope of the present disclosure for a provider to select a patient and colleague based on any variety of filtering criteria for the patient and/or colleague including, but not limited to, previously created encounters, known relationships between patients and providers, specialty, geolocation, availability, seniority, rating, and other factors. An exemplary graphical user interface of a search for a specialist is shown in FIGS. 5A and 5B.

In at least one embodiment of the present disclosure, the interface presented to the provider in the mobile application enables the provider to attach information associated with the patient in step 204. In such an embodiment, the provider may attach a patient to the encounter which enables a colleague to view clinical patient information upon viewing the encounter through a secure channel. In such an embodiment, the mobile application associates the patient with the encounter and indicates that the patient clinical information is to be retrieved from an electronic medical record portal upon interaction in the encounter by a colleague. In such an embodiment, the colleague, therefore, is presented with a similar experience as the provider in execution of step 105 and 106 in the method 100 when the colleague views the encounter through the mobile application as requested by the provider.

In at least one embodiment of the present disclosure, the provider may attach additional information about the patient in step 205. Additional information attached by the provider may include, but is not limited to, documents, files, photos, notes from the provider, recordings, and other information stored within the remote management application and/or generated by the provider during creation of the encounter. It should be appreciated that such additional information assists in enabling the colleague to efficiently handle the call as requested by the provider. An exemplary graphical user interface of a provider taking a photograph of an electrocardiogram for inclusion in an encounter is shown in FIG. 5C. An exemplary graphical user interface showing an escalation of an encounter is shown in FIG. 5D.

In at least one embodiment of the present disclosure, the provider may establish an urgency in step 205. In such an embodiment, the provider requesting a consult to a colleague may not know the availability of the colleague and, as such, may wish to be notified in the event that the colleague does not respond to the encounter within a certain timeframe. In such an embodiment, the provider may create an urgency rating for the request to have the mobile application notify the provider via push notification in the event that the colleague fails to respond within the set timeframe. In at least one embodiment of the present disclosure, the provider finishes creating the encounter through the mobile application and the remote management application transmits the encounter reference to the colleague through a mobile application installed on the colleague's electronic device in step 207.

Referring now to FIG. 2B, it is shown a method for remotely managing patients and critical information according to at least one embodiment of the present disclosure. As shown in FIG. 2B, a colleague receives an encounter reference through a mobile application in step 221. In such an embodiment, a colleague receives a push notification indicating that a provider has requested a consult from the colleague in step 221. In at least one embodiment of the present disclosure, the colleague activates the encounter reference through the mobile application and authenticates to the remote management application in step 222. In such an embodiment, the colleague transmits credentials to the remote management application in a secure communication channel over the Internet through the mobile application. In at least one embodiment of the present disclosure, the remote management application transmits the encounter to the colleague's mobile application in step 223. In at least one embodiment of the present disclosure, the colleague may interact with the patient through the mobile application in step 224 and document the encounter in step 225, similar to the steps 107 and 108 of the method 100 with the colleague replacing the provider in execution of these steps.

The colleague also may interact with the provider to facilitate the provider's request for a consult. In at least one embodiment of the present disclosure, the remote management application may receive an indication from the colleague that the encounter has been accepted in step 226. In such an embodiment, the colleague may transmit a message through the mobile application to the remote management application indicating that the colleague has accepted the encounter. For example, the colleague may send a secure text message through the mobile application to the provider as described above. In at least one embodiment of the present disclosure, the colleague may establish an urgency for the provider to respond to the message in step 277. In such an embodiment, the colleague may desire to learn that the provider has received indication that the colleague is working or not working on the encounter, so the colleague may establish an urgency in step 277 similar to the urgency identified by the provider in creation of the encounter in step 206 in execution of the method 200. In at least one embodiment of the present disclosure, the encounter acceptance and defined urgency is transferred from the mobile application of the colleague to the remote management application and then to the mobile application of the provider through a push notification to inform the provider that the colleague has accepted the encounter.

It should be appreciated that the execution of the steps 201 and 202 may occur in connection with the execution of the method 100, such as, for example, step 104. If, for example, a provider believes that he or she is not equipped to handle the specific patient call after execution of step 104 in the method 100, the execution of the method 200 may occur in order to escalate the call to a specialist or request a consult of a specialist. In such a situation, the specialist may communicate directly with the patient to resolve the patient call or the specialist may provide information to the provider in order to resolve the patient call.

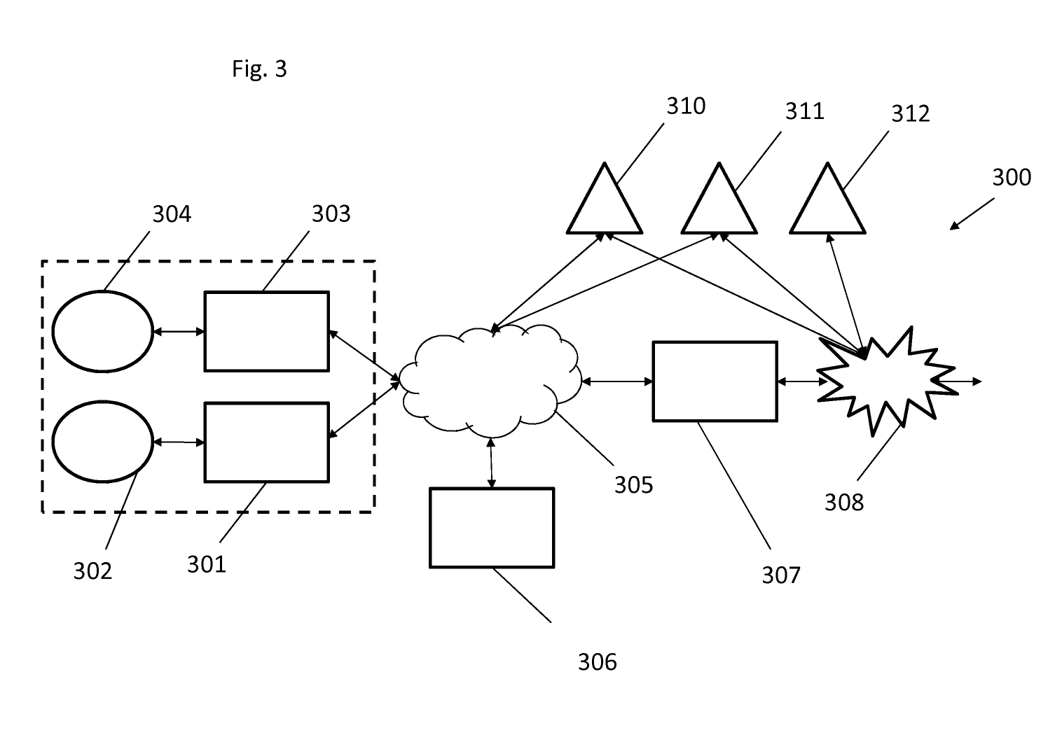

Referring now to FIG. 3, it is shown at least one embodiment of the components of the system for management of patients and critical information according to the present disclosure. System 200 comprises user devices 310, 311, and 312, remote management applications 301 and 303, databases 302 and 304, electronic medical record portal application 306, telephony server 307, computer network 305, and telephony network 308. For purposes of clarity, three user devices are shown in FIG. 3, including a patient user device 312, a provider user device 311, and a colleague user device 310. However, it is within the scope of the present disclosure that the system 300 may have more than three user devices 310, 311, and 312 operating at the same time or less than three user devices 310, 311, and 312 operating at the same time.

In at least one embodiment of the present disclosure, remote management applications 301, 303 and databases 302, 304 are housed within distinct infrastructure as depicted in the figure with a dotted line. The embodiment shown in the present disclosure displays two remote management applications 301, 303 and two connected databases 302, 304. It should be appreciated that it is within the scope of the present disclosure for more than two or less than two of each component is included. The embodiment displayed in FIG. 3, however, displays how the remote management applications 301, 303 and databases 302, 304 may be scaled to separate infrastructure for each provider and colleague group (i.e. doctor's office, hospital). It should be appreciated that this configuration separates infrastructure in a way that may satisfy one or more federal or State laws regarding the protection of storage and transfer of personally identifiable health information.

The remote management applications 301, 303 are housed on servers that may be configured to host a web-based application. In at least one embodiment of the present disclosure, the servers may include virtual infrastructure. In at least one embodiment of the present disclosure, the web-based application may be configured to send and receive patient information, encounters, calls, and other activity from one or more mobile applications configured on the user devices 310, 311, and 312. In at least one embodiment of the present disclosure, the remote management applications 301, 303 are configured to transfer and receive data from connected databases 302, 304. In at least one embodiment of the present disclosure, the web-based application may include components, code, or other attributes which enable the remote management applications 301, 303 to directly interact with providers and colleagues through the mobile applications on the user devices 310, 311, and 312. For example, the remote management applications 301, 303 may include application programming interface calls which the user devices 310, 311, and 312 may call through execution of the mobile applications to transfer and receive information.

The electronic medical record portal 306 may be configured to send patient information and generally interact with the remote management applications 301, 303 via the computer network 305 to receive requests for patient clinical information and transfer patient clinical information, and generally assist in performing the steps to the methods disclosed herein. The electronic medical record portal 306 may be configured to establish a virtual private network connection with one or more of the remote management applications 301, 303 through the computer network 305.

User devices 310, 311, 312 include one or more computers, computing devices, or systems of a type well known in the art, such as a mainframe computer, workstation, personal computer, laptop computer, hand-held computer, cellular telephone, or personal digital assistant. User devices 310, 311, 312 comprise such software, hardware, and componentry as would occur to one of skill in the art, such as, for example, one or more microprocessors, memory systems, input/output devices, device controllers, and the like User devices 310, 311, 312 also comprise one or more data entry means (not shown in FIG. 3) operable by users of user devices 310, 311, 312 for data entry, such as, for example, a pointing device (such as a mouse), keyboard, touchscreen, microphone, voice recognition, and/or other data entry means known in the art. User devices 310, 311, 312 also comprise a display means (not shown in FIG. 3) which may comprise various types of known displays such as liquid crystal diode displays, light emitting diode display, and the like upon which information may be display in a manner perceptible to the user. It should be appreciated that user device 312 associated with the patient may be as simple as a basic telephone.

The user devices 310, 311, and 312 are configured to provide input or receive output to/from the remote management applications 301, 303 to carry out one or more of the steps of the methods described herein. Remote management applications 301, 303 and electronic medical health record portal 306 comprise one or more server computers, computing devices, or systems of a type known in the art. Remote management applications 301, 303 and electronic medical health record portal 306 further comprise such software, hardware, and componentry as would occur to one of skill in the art, such as, for example, microprocessors, memory systems, input/output devices, device controllers, display systems, and the like. Remote management applications 301, 303 and electronic medical health record portal 306 may comprise one of many well-known servers, such as, for example, IBM's AS/400 Server, IBM's AIX UNIX Server, Linux, or MICROSOFT's WINDOWS Server. In FIG. 3, remote management applications 301, 303 and electronic medical health record portal 306 are shown and referred to herein each as a single server. However, remote management applications 301, 303 and electronic medical health record portal 306 may comprise a plurality of servers or other computing devices or systems interconnected by hardware and software systems know in the art.

The databases 302, 304 are configured to store activity and other information generated through execution of one or more of the steps of the methods described herein. Databases 302, 304 are “associated with” remote management applications 301, 303. According to the present disclosure, databases 302, 304 can be “associated with” remote management applications 301, 303 database 302 resides on remote management application 301 and database 304 resides on remote management application 303. In at least one embodiment, the remote server or computing device upon which database 302 resides is electronically connected to remote management application 301 such that the remote server or computing device is capable of continuous bi-directional data transfer with remote management application 301. A similar configuration for remote management application 303 and database 304 is within the scope of the present disclosure.

For purposes of clarity, databases 302, 304 are shown in FIG. 3, and referred to herein as each a single database. It will be appreciated by those of ordinary skill in the art that databases 302, 304 may comprise a plurality of databases connected by software systems of a type well known in the art, which collectively are operable to perform the functions delegated to databases 2302, 304 according to the present disclosure. Databases 302, 304 may comprise relational database architecture or other database architecture of a type known in the database art. Databases 302, 304 may comprise one of many well-known database management systems, such as, for example, MICROSOFT's SQL Server, MICROSOFT's ACCESS, or IBM's DB2 database management systems, or the database management systems available from ORACLE or SYBASE.

Each component in the system 300 communicates with other electronically coupled components through the computer network 305. The network 305 may include, but is not limited to, the Internet, a WAN, LAN, private network, public network, or any other type of computer network. The communication between any component and another computer may be bidirectional. User devices 310, 311, 312 may include any type of device able to receive a communication, such as, for example, a smartphone, PDA, tablet, gaming system, personal computer, laptop, and cell phone.

Telephone network 308 may include a telecommunications network for telephone calls, including, but not limited to, a cellular telephone network, a fixed line network, a wireless network, a private network, and/or a public telephone network provided by one or more public telephone operators. Each user device 310, 311, 312 may submit calls to the telephony server 307 through the telephone network 308. For example, user device 312 for the patient may place a call through telephony network 308 to telephony server 307. Telephony server 307 then transmit the information associated with the telephone call to one or more remote management application 301, 303.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein and in the appended claims represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

We claim:

1. A computerized method for management of patients and critical information, the method comprising:
receiving a medical request from a user at a processor;
determining at least one health care provider that is appropriate for receiving the medical request from the user using the processor;
sending a notification to at least one mobile device of the at least one health care provider comprising a graphical user interface regarding the medical request;
sending data from the processor to the at least one mobile device, wherein the data comprises at least a portion of the medical request, at least a portion of a medical record, and at a least a portion of a patient contact information; and
facilitating at least one contact between the at least one mobile device and the user through the processor.

2. The method of claim 1, further comprising receiving at least one procedural billing code from the at least one mobile device at a processor.

3. The method of claim 2, wherein the at least one procedural billing code is associated with one or more health care fees.

4. The method of claim 1, wherein the at least one contact is a telephone call.

5. The method of claim 1, wherein the at least one contact is a text message and the facilitating step is accomplished through establishing an encrypted connection between the at least one mobile device and the processor whereby the at least one contact is transmitted.

6. The method of claim 1, wherein the medical request includes one or more photographs or voice recordings.

7. The method of claim 1, further comprising receiving an information from the at least one mobile device indicative of a result of the at least one health care provider responding to the medical request.

8. The method of claim 7, wherein the result includes a voice recorded note from the health care provider.

9. A system for management of patients and critical information, the system comprising:
a first server, the first server configured to receive at least one medical request from a first user device and transfer the at least one medical request from a patient to a second user device; and
a second server, the second server electronically coupled to the first server and configured to transmit medical information of the patient to the first server;
wherein the first server transmits the at least one medical request and the patient medical information to the second user device upon receiving an authorized login from the second user device.

10. The system of claim 9, wherein the connection between the first server and the second server comprises a virtual private network.

11. The system of claim 9, further comprising:
a third user device, the third user device electronically coupled to the first server;
wherein the first server is further configured to transmit the medical request and patient information to the third user device upon receiving an indication from the second user device.

12. The system of claim 9, further comprising a database, the database electronically coupled to the first server and configured to store the medical request and an information associated with the second user device responding to the medical request.

13. A computerized method for managing patients and critical information, the method comprising:
receiving a medical request from a user at a processor;
identifying the user based at least in part on a demographics information stored about the user in a database;
transmitting the medical request and a user clinical information to a first mobile device, wherein the first mobile device is operated by a health care provider;
receiving an request from the first mobile device to escalate the medical request to a specialist;
identifying a second mobile device with the processor, wherein the second mobile device is associated with the specialist; and
transmitting the medical request and the user clinical information to the second mobile device.

14. The method of claim 13, further comprising:
receiving a resolution of the medical request from the second mobile device, wherein the resolution includes at least one of a procedural billing code and a note from the specialist.

15. The method of claim 13, wherein the medical request includes at least photograph of a result of a health test.

16. The method of claim 15, wherein the health test is an electrocardiogram.

17. The method of claim 13, further comprising
receiving an urgency timing from the first mobile device; and
alarming the first mobile device in the event that the second mobile device does not respond to the medical request within the urgency timing.

18. A computerized method for management of patients and critical information, the method comprising:
receiving a medical request at a processor from a patient;
identifying the patient and an available health care provider from a database with a processor;
sending a push notification to a first mobile device, wherein the first mobile device is operated by the available health care provider and the push notification includes a reference to the medical request; and
transmitting the medical request and a clinical information of the patient to the first mobile device upon receipt of the reference at the processor.

19. The method of claim 18, further comprising:
facilitating a connection between the health care provider and the patient through a processor, wherein the connection includes a response from the health care provider to the medical request through the first mobile device.

20. The method of claim 18, wherein the medical request includes a photograph of a test result.
